(19) United States
(12) Patent Application Publication
(10) Pub. No.: US 2018/0340106 A1
(43) Pub. Date: Nov. 29, 2018

(54) B-STAGEABLE ADHESIVE COMPOSITION

(71) Applicants: Ping ZHOU, Shanghai (CN); 3M INNOVATIVE PROPERTIES COMPANY, St. Paul, MN (US)

(72) Inventors: Ping Zhou, Shanghai (CN); Lianzhou Chen, Woodbury, MN (US); Liang Qin, Shanghai (CN); Lin Yang, Shanghai (CN); Qunying Yang, Shanghai (CN)

(21) Appl. No.: 15/776,545

(22) PCT Filed: Dec. 1, 2015
(86) PCT No.: PCT/CN2015/096105

§ 371 Date: May 16, 2018

(51) Int. Cl. C09J 163/00; C09J 161/14; C09J 11/04; C09J 9/00; C09K 5/14

(52) U.S. Cl. CPC C09J 163/00; C09J 161/14; C09K 5/14; C09J 9/00; C09J 11/04

(57) ABSTRACT

The invention provides a B-stageable adhesive composition, based on the total weight of the adhesive composition, comprising: 13-59 wt % of an epoxy resin; 18-69 wt % of a carboxyl terminated butadiene-acrylonitrile copolymer; and 3-34 wt % of a polyterpene modified phenol-formaldehyde resin. Additionally, the B-stageable adhesive composition may further comprise a hardener, an inorganic filler including a flame retardant agent, a thermal conductive filler or the like. According to the disclosure of the application, a new B-stageable adhesive composition having a high tackiness, a high temperature resistance, a high flame resistance and a high thermal conductivity can be provided.

### FIELD OF THE INVENTION

The present invention generally relates to the field of adhesive application, and specifically, relates to a B-stageable adhesive composition used in the field of automobile industry, electronic industry or the like.

### BACKGROUND OF THE INVENTION

Due to the good bonding strength on different substrates and high temperature resistance or the like, epoxy resins are widely used to provide an adhesive composition in industrial application, which is used for mirror bonding in automobile industry, high bonding for components in electronic application, transformers in electric application or the like.

The attempt to use the traditional epoxy adhesives in the above technical fields often creates expensive production bottlenecks, because, as soon as the epoxy adhesives are applied, the applied components had to be assembled and cured immediately. In order to overcome this defect, various B-stageable adhesives have been widely utilized. The B-stageable adhesives eliminate these bottlenecks by allowing the manufacturing process to be proceed efficiently, with each step performed on larger batches of product.

For example, U.S. Pat. No. 5,292,812 discloses an adhesive composition consisting essentially of an epoxy resin; a carboxyl group-containing acrylonitrile-butadiene or methacrylonitrile-butadiene copolymer or a combination thereof; a maleimide compound; and an imidazole compound. The resultant compositions are electrically insulative, thermally resistant, highly capable of fabrication at low pressure and stable storage.

Additionally, Chinese Application CN 101314694 provides an insulative resin paint comprising an epoxy resin; a phenol-formaldehyde resin; an epoxy toughener; a leveling agent; and a diluent. This insulative resin paint has good bonding strength to a silicon steel sheet and high temperature resistance.

However, when a B-stageable adhesive composition is produced for the above applications, because of the poor tackiness between the various substrates and a B-stageable adhesive film, the customer needs to clamp the adhesive film at a prescribed position and develop the bonding strength at an elevating temperature so as to get a fully curing structure. It is an energy-cost for heating and very complex assembling process for the customer.

Therefore, there is a need to develop a new B-stageable adhesive composition having high tackiness, which can be easily provided at a prescribed position at room temperature, and then cured at an elevated temperature without additional pressure, so as to form a cured structure having a good bonding strength. With these benefits, it can further simplify the customer operation process, and achieve the improved product reliability and the productivity of customer process.

### SUMMARY OF THE INVENTION

In order to develop a new B-stageable adhesive composition having high tackiness, the present inventors have made intensive study. The present inventors have surprisingly found that when an epoxy resin, a carboxyl terminated butadiene-acrylonitrile copolymer and a polyterpene modified phenol-formaldehyde resin are mixed at a specific ratio, an adhesive composition which has good tackiness and the cured product thereof has good bonding strength may be achieved. Additionally, by adjusting the additives to be added into the adhesive composition, the B-stageable adhesive composition can be developed with additional excellent multi-functional properties, such as flame resistance, thermal conductivity or the like.

Therefore, an aspect of the present invention provides a B-stageable adhesive composition, based on the total weight of the adhesive composition, comprising:

13-59 wt % of an epoxy resin;

18-69 wt % of a carboxyl terminated butadiene-acrylonitrile copolymer; and

3-34 wt % of a polyterpene modified phenol-formaldehyde resin.

The present invention has the following advantageous effects. By specifically selecting an epoxy resin, a carboxyl terminated butadiene-acrylonitrile copolymer and a polyterpene modified phenol-formaldehyde resin at a specific ratio, the prepared adhesive composition may have excellent tackiness. Additionally, by adjusting the additives to be added into the adhesive composition, the B-stageable adhesive composition can be developed with additional multi-functional properties, such as flame resistance, thermal conductivity or the like.

### DETAILED DESCRIPTION OF THE INVENTION

In the present invention, the term “a B-stageable adhesive composition” has the traditional meaning in the field, unless otherwise specifically indicated. B-staging is a process that utilizes heat or UV light to remove the majority of a solvent from an adhesive, thereby allowing the construction to be “staged.” In between the processes of coating, assembling and curing of the adhesive composition, the adhesive composition can be held for a period of time, without sacrificing the performances thereof.

An aspect of the present invention provides a B-stageable adhesive composition, based on the total weight of the adhesive composition, comprising:

13-59 wt % of an epoxy resin;

18-69 wt % of a carboxyl terminated butadiene-acrylonitrile copolymer; and

3-34 wt % of a polyterpene modified phenol-formaldehyde resin.

According to certain embodiments of the present invention, an epoxy resin is incorporated into the B-stageable adhesive composition to be used as a matrix. The epoxy resin has an epoxy equivalent weight of no more than 1000, preferably no more than 800, and more preferably no more than 500. When the epoxy equivalent weight is no more than 1000, the B-stageable adhesive composition has good tackiness. Based on the total weight of the adhesive composition, the content of the epoxy resin is 13-59 wt %, preferably 35-59 wt %. When the content of the epoxy resin is 13-59 wt %, the B-stageable adhesive composition has good tackiness and the cured product thereof has good bonding strength. The specific kinds of the epoxy resin to be used in the invention are not specifically limited as long as they satisfy the about requirements. According to certain embodiments of the present invention, the epoxy resin is selected from the group consisting of bisphenol A epoxy resin, bisphenol F epoxy resin, phenolic epoxy resin, glycidyl ether epoxy resin, polyurthane modified epoxy resin and the like. One specific example of the epoxy resin is NPEL 128 (Trade Name) from NAN YA EPDXY CORP (Kunshan Campus), which is a bisphenol A epoxy resin having the epoxy equivalent weight of 188.

According to certain embodiments of the present invention, the B-stageable adhesive composition comprises a carboxyl terminated butadiene-acrylonitrile (CTBN) copolymer as a toughener. The carboxyl terminated butadiene-acrylonitrile copolymer has a mass average molecular weight of no less than 10000, preferably no less than 100000, and more preferably no less than 200000. The weight average molecular weight of the carboxyl terminated butadiene-acrylonitrile (CTBN) copolymer is in a range of, preferably 100000-400000, and more preferably 200000-300000. When the mass average molecular weight is no less than 10000, the cured product of the B-stageable adhesive composition has good bonding strength. Based on the total weight of the adhesive composition, the content of the carboxyl terminated butadiene-acrylonitrile copolymer is 18-69 wt %, preferably 21-48 wt %. When the content of the carboxyl terminated butadiene-acrylonitrile copolymer is 18-69 wt %, the B-stageable adhesive composition has good tackiness and the cured product thereof has good bonding strength. One specific example of the carboxyl terminated butadiene-acrylonitrile copolymer is 1072CGX (Trade Name) from ZEON Corporation, which has a mass average molecular weight of no less than 10000.

According to certain embodiments of the present invention, the B-stageable adhesive composition comprises a polyterpene modified phenol-formaldehyde resin used as a tackifier and a high temperature hardener. Based on the total weight of the adhesive composition, the content of the polyterpene modified phenol-formaldehyde resin is 3-34 wt %, preferably 5-30 wt %, and more preferably 15-28 wt %. When the content of the polyterpene modified phenol-formaldehyde resin is 3-34 wt %, the B-stageable adhesive composition has good tackiness and the cured product thereof has good bonding strength. One specific example of the polyterpene modified phenol-formaldehyde resin is T-803L (Trade Name) from ARAKAWA CHEMICAL INDUSTRIES LTD, which can act as a tackifier and even as a hardener under high temperature treatment.

The reaction mechanism of the above three components according to the application may be described as follows. The carboxyl groups in the carboxyl terminated butadiene-acrylonitrile (CTBN) copolymer can react with the epoxy groups in the epoxy resin at low temperature to form a B-stageable film. Meanwhile, CTBN used in this article acts as a toughener, and the molecular weight of this CTBN is very high, which had good miscibility with the epoxy resin, and excellent mixable with the fillers. Furthermore, the polyterpene modified phenol-formaldehyde resin has a good compatibility with the epoxy resin, and acts as a tackifier at low temperature to provide the good tackiness, and additionally, it can also act as hardener for the epoxy resin at a higher temperature to provide good bonding strength.

During the curing process of the B-stageable adhesive composition, additional hardener can be added into the composition, which reacts with the epoxy groups in the epoxy resin at a high temperature to get a fully curing structure so as to improve the high temperature resistance performance of the resultant product. Based on the total weight of the adhesive composition, the content of the additional hardener is 0.5-5 wt %. The specific kinds of the additional hardener to be used in the invention are not specifically limited, and the hardener is selected from the group consisting of dicyandiamide, 4,4′-diaminodiphenylsulfone (DDS), anhydrides, mercaptans, imidozles, ureas, amides and the like. Preferably, the hardener is dicyandiamide. One specific example of dicyandiamide is Dicy (Trade Name) from NINGXIA DARONG CHEMCIALS & METALLURY CO. LTD.

According to certain embodiments of the present invention, in addition to the above components, the B-stageable adhesive composition further comprises an inorganic filler for improving the performances of the cured product. Based on the total weight of the adhesive composition, the content of the organic filler is 0-70 wt %, preferably 20-60 wt %, and more preferably 30-50 wt %. Specifically, the inorganic filler comprises one or more of a flame retardant agent, a thermal conductive filler, or the like. Based on the total weight of the adhesive composition, the content of the flame retardant agent is 0-40 wt %, preferably 10-40 wt %, and more preferably 20-40 wt %. The flame retardant agent is selected from the group consisting of aluminum hydroxide, phosphates and a mixture thereof. Furthermore, based on the total weight of the adhesive composition, the content of the thermal conductive filler is 0-40 wt %, preferably 20-40 wt %, and more preferably 30-40 wt %. The thermal conductive filler is selected from the group consisting of boron nitride, aluminum hydroxide and a mixture thereof. The specific examples of the flame retardant agent are 140LEO (Trade Name) from Albemarle Corporation and OP935 (Trade Name) from Clariant Corporation. One specific example of the thermal conductive filler is Boron Nitride (BN) (Trade Name) from Dandong Thermal Co. Ltd.

According to certain embodiments of the present invention, the B-stageable adhesive composition further comprises a solvent for dissolving the above components. There is no limitation about the specific kinds of the solvent as long as the above components may be fully dissolved therein. Preferably, the solvent may be selected from the group consisting of butanone, acetone, N, N-dimethyl acetamide, toluene and the like. Most preferably, the solvent is butanone. Based on the total weight of the adhesive composition, the content of the solvent is 20-70 wt %, preferably 20-50 wt %, and more preferably 30-50wt %.

The method for preparing the B-stageable adhesive composition comprising the step of mixing the components of the B-stageable adhesive composition provided in the present invention.

According to certain embodiments of the present invention, the temperature of the mixing step is 5-60° C., and the pressure of the mixing step is 0.5-2 atm.

### Testing Methods:

In the present invention, the B-stageable adhesive compositions prepared according to the following different preparing conditions were subjected to various tests for verifying the performances thereof in terms of Initial Tackiness, Over Lap Shear (OLS) strength, T-Peel strength, Flame Resistance, and Thermal Conductivity.

The testing methods for the above characteristics are as follows:

1. Tackiness

Tackiness is an important performance of the B-stageable adhesive composition and a good initial tackiness can allow the B-stageable adhesive film to be easily provided at a prescribed position at room temperature, and then cured at an elevated temperature without additional pressure, so as to form a cured structure having a good bonding strength. Tackiness is evaluated in the application by measuring the 180 degree peel strength under room temperature (25° C.), according to ASTM D1000. Specifically, a sample of the adhesive film formed by a B-stageable adhesive composition is laminated on a 1 mil polyimide (PI) film (HV-25, Rayitek Film Company) at room temperature. The laminated structure is then cut into a size with a width of 0.5 inch, and the adhesion strength thereof is measured on a SUS substrate (304#, ChemInstrument Company) according to ASTM D1000.

In the tackiness test, the ATS value of the B-stageable adhesive composition was measured according to the following standards showed in Table 1.

TABLE 1

| ATS | Tackiness |
|---|---|
| 0.1-0.5 N/mm | Good |
| 0.5-1.0 N/mm | Very Good |
| ≥1.0 N/mm | Excellent |

2. T-Peel Strength

In order to investigate the bonding strength of the finally cured product formed by the B-stageable adhesive composition, a sample of the adhesive film formed by a B-stageable adhesive composition is tested for T-Peel strength according to ASTM D1002. Specifically, a sample of a B-stageable adhesive film obtained from the B-stageable adhesive composition is adhered to a copper substrate having a thickness of 0.3 mm with manual pressure, and then put into an oven at 185° C. to be cured for 40 minutes without pressure. Then, according to ASTM D1002, the T-peel performances are tested under a room temperature (25° C.), under the following conditions: Substrate: copper; Speed: 50mm/min; Sample size: 1 inch².

In the T-Peel strength test, the value of T-Peel strength test of the cured product of the B-stageable adhesive composition was measured according to the following standards showed in Table 2.

TABLE 2

| T-Peel Strength | Bonding Strength |
|---|---|
| 0.3-0.8 N/mm | Good |
| 0.8-1.1 N/mm | Very Good |
| ≥1.1 N/mm | Excellent |

3. Flame Resistance

In order to investigate the Flame Resistance of the finally cured product formed by the B-stageable adhesive composition, the B-stageable adhesive composition is tested for

Flame Resistance according to UL94. Specifically, specimens are cut to be 125±5 mm long by 13.0±0.5 mm wide. Before testing, Specimens are preconditioned at 23±2° C. and 50±5% relative humidity for a minimum of 48 hours. Five samples are tested, and each sample was under fire (fire height 2 mm) for 10 s. The afterflame time for each individual specimen is less than 10 s, and the total afterflame time for five samples is less than 50 s.

With regard to the experimental data achieved in the above process, this standard can be clarified as UL94V0, V1, V0, and when the value of Flame Resistance is UL94V0, the corresponding B-stageable adhesive composition can be regarded as “acceptable” for some special application.

4. Thermal Conductivity

In order to investigate the Thermal Conductivity of the finally cured product formed by the B-stageable adhesive composition, the B-stageable adhesive composition is tested for Thermal Conductivity according to ASTM D5470.

With regard to the experimental data achieved in the above process, when the value of Thermal Conductivity is 0.8 W/m.K, the corresponding B-stageable adhesive composition is “acceptable” for some special application.

### EXAMPLES

The present invention is further illustrated by the following examples which should not be construed to limit the scope of the present invention. All parts and percentages are by weight unless otherwise indicated.

The following raw materials as shown in Table 3 were used for the examples in the examples of present invention.

TABLE 3

| | | Trade | Remark and |
|---|---|---|---|
| Material | Composition | Name | source information |
| Epoxy Resin | Bisphenol A epoxy | NPEL 128 | — |
| | resin | | |
| Toughener | CTBN | 1072CGX | CTBN |
| Tackifier | Polyterpene modified | T-803L | Polyterpene modify |
| | Phenol-formaldehyde | | Phenol-formaldehyde |
| | | | resin |
| Filler | Aluminum hydroxide | 104LEO | A flame retardant filler |
| | hydrate | | |
| Filler | Phosphate filler | OP935 | A flame retardant filler |
| Filler | Boron Nitride | BN | A thermal conductive |
| | | | filler |
| Hardener | Dicyandiamide | Dicy | — |

The chemical reagents in addition to the reagents listed in Table 3 are all from the common commercial sources.

### Example 1

At 23° C., 7 g of 104LEO, 13 g of OP935, and 34 g of BN were dispersed into butanone to form slurry. After stirring the slurry for 15 minutes, 22 g of NPEL128, 3 g of T803L, 1 g of Dicy and 20 g of 1072CGX were added into the slurry. The slurry was mixed for 15-20 minutes. At the same time, additional butanone was added into the slurry to adjust the solid contents of NPEL128, 1072CGX, T803L, 140LEO, OP935, BN, and Dicy to be 22 wt %, 20 wt %, 3 wt %, 7 wt %, 13 wt %, 34 wt %, and 1 wt % based on the total weight of the final slurry, respectively.

Then, the slurry was coated on a release liner BY-1 from Bao Yao Company to get an adhesive film having a thickness of about 0.25 mm. Then, the obtained laminated structure was put into an oven at 110° C. and dried for 10-15 minutes to dry out the solvent.

The adhesive film was peeled from the release liner and used as Sample 1 for further testing.

### Examples 2-14 and Comparative Example 1-5

Different adhesive films were prepared by following the same procedure under the same conditions as described in Example 1, except that the contents of respective components were selected as shown in Table 4.

TABLE 4

| Examples | NPEL128 | 1072CGX | T-803L | 104LEO | OP935 | BN | Dicy | Sum |
|---|---|---|---|---|---|---|---|---|
| Example 1 | 22 g | 20 g | 3 g | 7 g | 13 g | 34 g | 1 g | 100% |
| Example 2 | 22 g | 20 g | 5 g | 7 g | 13 g | 33 g | 1 g | 100% |
| Example 3 | 21 g | 19 g | 9 g | 6 g | 13 g | 31 g | 1 g | 100% |
| Example 4 | 20 g | 18 g | 12 g | 6 g | 12 g | 30 g | 1 g | 100% |
| Example 5 | 36 g | 32 g | 30 g | 0 g | 0 g | 0 g | 2 g | 100% |
| Example 6 | 37 g | 34 g | 27 g | 0 g | 0 g | 0 g | 2 g | 100% |
| Example 7 | 49 g | 28 g | 20 g | 0 g | 0 g | 0 g | 3 g | 100% |
| Example 8 | 35 g | 48 g | 15 g | 0 g | 0 g | 0 g | 2 g | 100% |
| Example 9 | 18 g | 49 g | 31 g | 0 g | 0 g | 0 g | 1 g | 100% |
| Example 10 | 13 g | 53 g | 34 g | 0 g | 0 g | 0 g | 1 g | 100% |
| Example 11 | 59 g | 21 g | 20 g | 0 g | 0 g | 0 g | 0 g | 100% |
| Example 12 | 48 g | 49 g | 3 g | 0 g | 0 g | 0 g | 0 g | 100% |
| Example 13 | 11 g | 65 g | 24 g | 0 g | 0 g | 0 g | 0 g | 100% |
| Example 14 | 42 g | 30 g | 28 g | 0 g | 0 g | 0 g | 0 g | 100% |
| Comparative | 8 g | 56 g | 36 g | 0 g | 0 g | 0 g | 0% | 100% |
| Example 1 | | | | | | | | |
| Comparative | 49 g | 49 g | 1 g | 0 g | 0 g | 0 g | 0% | 100% |
| Example 2 | | | | | | | | |
| Comparative | 5 g | 72 g | 24 g | 0 g | 0 g | 0 g | 0% | 100% |
| Example 3 | | | | | | | | |
| Comparative | 8 g | 69 g | 23 g | 0 g | 0 g | 0 g | 0% | 100% |
| Example 4 | | | | | | | | |
| Comparative | 66 g | 15 g | 20 g | 0 g | 0 g | 0 g | 0% | 100% |
| Example 5 | | | | | | | | |

The samples 1-14 and C1-C5 of the adhesive films prepared in Examples 1-14 and Comparative Example 1-5 were subjected to the tests for verifying the performances thereof in terms of Initial Tackiness, T-Peel strength, Flame Resistance, and Thermal Conductivity according to the Testing Methods as described above. The obtained results thereof were shown in Table 5.

TABLE 5

| | | | T-peel | Flame | Thermal |
|---|---|---|---|---|---|
| | Thickness | ATS | @25° C. | Retardant | Conductivity |
| Lot No. | mm | N/mm | N/mm | Pass | 0.8 W/m · K |
| Example 1 | ~0.25 | 0.14 | 0.96 | Pass | 0.8 W/m · K |
| Example 2 | ~0.26 | 0.21 | 1.08 | Pass | 0.8 W/m · K |
| Example 3 | ~0.24 | 0.30 | 1.23 | Pass | 0.8 W/m · K |
| Example 4 | ~0.24 | 0.39 | 1.26 | Pass | 0.8 W/m · K |
| Example 5 | ~0.22 | 1.00 | 0.77 | — | — |
| Example 6 | ~0.23 | 1.21 | 1.04 | — | — |
| Example 7 | ~0.24 | 1.20 | 0.90 | — | — |
| Example 8 | ~0.24 | 0.80 | 1.35 | — | — |
| Example 9 | ~0.22 | 0.50 | 1.70 | — | — |
| Example 10 | ~0.21 | 0.48 | 1.72 | — | — |
| Example 11 | ~0.20 | 1.30 | 1.25 | — | — |
| Example 12 | ~0.20 | 1.20 | 0.67 | — | — |
| Example 13 | ~0.20 | 0.90 | 0.43 | — | — |
| Example 14 | ~0.20 | 1.30 | 1.50 | — | — |
| Comparative | ~0.23 | <0.10 | 0.20 | — | — |
| Example 1 | | | | | |
| Comparative | ~0.20 | 1.13 | 0.15 | — | — |
| Example 2 | | | | | |
| Comparative | ~0.20 | <0.10 | 0.14 | — | — |
| Example 3 | | | | | |
| Comparative | ~0.20 | <0.10 | 0.37 | — | — |
| Example 4 | | | | | |

| | |
|---|---|
| Comparative | No film was formed |
| Example 5 | |

According to the Examples 1-14, Comparative Example 1-5 and the test results thereof shown in Tables 4 and 5, the B-stageable adhesive composition provided in the present invention has good tackiness and the cured product thereof has good bonding strength.

Especially, according to the Example 6, 7, 8, 11 and 14, when the amount of the epoxy resin is 35-59 wt %, the amount of the carboxyl terminated butadiene-acrylonitrile copolymer is 21-48 wt %, and the amount of the polyterpene modified phenol-formaldehyde resin is 15-28 wt %, the B-stageable adhesive composition has very good tackiness and the cured product thereof has very good bonding strength.

According to the Comparative Example 1, the amount of the epoxy resin is too low, the amount of the polyterpene modified phenol-formaldehyde resin is too high, and therefore, neither the tackiness of the adhesive composition, nor the bonding strength of the cured product of the adhesive composition is acceptable.

According to the Comparative Example 2, the amount of the polyterpene modified phenol-formaldehyde resin is too low, therefore the bonding strength of the cured product of the adhesive composition is not acceptable.

According to the Comparative Example 3, the amount of the epoxy resin is too low, the amount of the carboxyl terminated butadiene-acrylonitrile copolymer is too high, and therefore, neither the tackiness of the adhesive composition, nor the bonding strength of the cured product of the adhesive composition is acceptable.

According to the Comparative Example 4, the amount of the epoxy resin is too low, the amount of the carboxyl terminated butadiene-acrylonitrile copolymer is too high, and therefore, the tackiness of the adhesive composition, is not acceptable. According to the Comparative Example 5, the amount of the epoxy resin is too high, the amount of the carboxyl terminated butadiene-acrylonitrile copolymer is too low, and therefore, the cured product of the adhesive composition after being cured was too brittle to form a film.

Although the invention is described with reference to the examples in detail, it is noted that the invention is not limited to the examples. The invention can be changed or modified without departing from the spirit of the invention.

What is claimed is:

1. A B-stageable adhesive composition, based on the total weight of the adhesive composition, comprising:
13-59 wt % of an epoxy resin;
18-69 wt % of a carboxyl terminated butadiene-acrylonitrile copolymer; and
3-34 wt % of a polyterpene modified phenol-formaldehyde resin.

2. The B-stageable adhesive composition according to claim 1, wherein the epoxy resin has an epoxy equivalent weight of no more than 1000.

3. The B-stageable adhesive composition according to claim 1, wherein the epoxy resin is selected from the group consisting of bisphenol A epoxy resin, bisphenol F epoxy resin, phenolic epoxy resin, glycidyl ether epoxy resin, and polyurthane modified epoxy resin.

4. The B-stageable adhesive composition according to claim 1, wherein the content of the epoxy resin is 35-59 wt %.

5. The B-stageable adhesive composition according to claim 1, wherein the carboxyl terminated butadiene-acrylonitrile copolymer has a mass average molecular weight of no less than 10000.

6. The B-stageable adhesive composition according to claim 1, wherein the content of the carboxyl terminated butadiene-acrylonitrile copolymer is 21-48 wt %.

7. The B-stageable adhesive composition according to claim 1, wherein the content of the polyterpene modified phenol-formaldehyde resin is15-28 wt %.

8. The B-stageable adhesive composition according to claim 1, wherein the B-stageable adhesive composition further comprises 0.5-5 wt % of a hardener.

9. The B-stageable adhesive composition according to claim 8, wherein the hardener is selected from the group consisting of dicyandiamide, 4,4′-diaminodiphenylsulfone, anhydrides, mercaptans, imidozles, ureas, and amides.

10. The B-stageable adhesive composition according to claim 8, wherein the hardener is dicyandiamide.

11. The B-stageable adhesive composition according to claim 1, wherein the B-stageable adhesive composition comprises 0.5-5 wt % of dicyandiamide based on the total weight of the adhesive composition.

12. The B-stageable adhesive composition according to claim 1, wherein the B-stageable adhesive composition further comprises 0-70 wt % of an inorganic filler based on the total weight of the adhesive composition.

13. The B-stageable adhesive composition according to claim 12, wherein the inorganic filler comprises one or more of a flame retardant agent and a thermal conductive filler.

14. The B-stageable adhesive composition according to claim 1, wherein the B-stageable adhesive composition further comprises 0-40 wt % of a flame retardant agent selected from the group consisting of aluminum hydroxide, phosphates and a mixture thereof.

15. The B-stageable adhesive composition according to claim 1, wherein the B-stageable adhesive composition further comprises 0-40 wt % of a thermal conductive filler selected from the group consisting of boron nitride, aluminum hydroxide and a mixture thereof.

16. The B-stageable adhesive composition according to claim 1, wherein the B-stageable adhesive composition further comprises a solvent.

17. The B-stageable adhesive composition according to claim 16, wherein the solvent is butanone.
